(19) United States
(12) Patent Application Publication
(10) Pub. No.: US 2019/0016064 A1
(43) Pub. Date: Jan. 17, 2019

(54) STRUCTURAL ELEMENT OF AN AIRCRAFT PART AND METHOD FOR MANUFACTURING A STRUCTURAL ELEMENT

(71) Applicant: Rolls-Royce Deutschland Ltd & Co KG, Blankenfelde-Mahlow (DE)

(72) Inventors: Predrag TODOROVIC, Berlin (DE); Thomas KUBISCH, Koenigs-Wusterhausen (DE)

(21) Appl. No.: 15/753,469

(22) PCT Filed: Sep. 15, 2016
(86) PCT No.: PCT/EP2016/071835

§ 371 Date: Feb. 19, 2018

(30) Foreign Application Priority Data
Sep. 17, 2015 (DE) 10 2015 217 859.5

(51) Int. Cl. B29C 70/24; B64D 29/00; B64F 5/10

(52) U.S. Cl. CPC B29C 70/24; B32B 5/12; B64F 5/10; B64D 29/00

(57) ABSTRACT

A structural element of an aircraft part, in particular an aircraft engine part, with at least partly a double-curvature shape, including a plurality of sets of fibers in textile fabric structure, wherein in at least one region of the structural element the number of fibers in one direction is reduced per area in a flattened out state of the textile fabric structure. It also relates to a method for manufacturing a structural element.

### CROSS-REFERENCE TO A RELATED APPLICATION

This application is a National Phase patent application of International Patent Application Number PCT/EP2016/071835, filed on Sep. 15, 2016, which claims priority of German Patent Application Number 10 2015 217 859.5, filed on Sep. 17, 2015.

### BACKGROUND

The invention relates to a structural element of an aircraft part and a method for manufacturing a structural element of an aircraft part.

The requirements for the weight and structural properties of aircraft parts are stringent. In many cases the aircraft parts have to be structurally robust while being light weighted. Therefore, many parts use lightweight metals such as aluminum or composite materials. The latter comprise layers of fibers and resin (in particular pre-pregs) which overlap at least in parts. Those overlapping parts create uneven surfaces which either need reworking or which cause aerodynamic losses and non-satisfactory esthetic appearance.

### SUMMARY

Therefore, composite structural elements which are easy to manufacture and structurally suitable for aircraft applications are needed.

The structural element with features as described herein addresses these issues.

The structural element comprises at least partly a double-curvature shape and a plurality of sets of fibers in a textile fabric structure wherein in at least one region of the structural element the number of fibers is reduced in one direction. The reduction of fibers is taken to be per area in a flattened out state of the textile fabric structure. When the textile fabric structure is built into the structural element, i.e. the textile fabric structure is enveloped around the double-curvature shape, the fibers move closer together. This way it is possible to have a structural element with a uniform (or essentially uniform) fiber-per-area density in curved areas, in particular in the region of the typically very complex double-curvature shape. The thinning out of the fibers in the base material, i.e. the textile fabric structure, allows this. This means that in that region per unit area of the flattened out textile fabric structure the density of fibers is lower than in the parts of the structural element outside the region. Basically, the region provides a part of the structural element which is deliberated thinner than other parts (referring to a flattened, in-plane shape). This allows an overlapping-prepreg-less structural element.

In one embodiment, the reduction of fibers in the at least one region of the textile fabric structure creates a gap due to a reduced density of fibers in that region, which is changed once fibers enveloped over the double-curvature shape.

Since the structural element comprises a double-curvature shape, in one embodiment, the region with the reduced number of fibers (i.e. in the flattened out state of the textile fabric structure) is located in an area with a maximum curvature in at least one spatial direction. This prevents that the curvature causes a thickening or wrinkling of the textile fabric structure in the part where the maximum curvature occurs. In a further embodiment, the region with the reduced number of fibers is positioned in a circumferential direction of the structural element.

In an embodiment of the completed structural element (which can comprise a plurality of textile fabric structures) the fiber density (fibers per area) in the region of the double-curvature shape is uniform or essentially uniform. This is the effect of the thinning out of the fibers in the flattened out textile fabric structure.

The set of fibers can be splice-free oriented and/or positioned to form the structural element, in particular a three-dimensional structure in a further embodiment.

Furthermore, the structural element can e.g. comprise a set of fibers at least partially overlapping between each other in the region with reduced number of fibers.

It is also possible that the set of fibers are positioned at least partially in different textile layers. The region with the reduced number of fibers would then be present when the layers are put on top of each other.

In another embodiment, the structural element comprises a double-curvature shape form with a first curvature around a closed circumference and a second curvature in axial direction. Such curved shapes occur e.g. in ring-like structures (for example sphere segments, toroids etc).

In one embodiment, at least three sets of fibers in particular layers of carbon fibers, Kevlar fibers and/or glass fibers, are embedded in a matrix material, in particular resin, forming a composite structural element.

One application of an embodiment is a structural element as a part of an aircraft part, in particular a three-dimensional (quasi) axisymmetric part, in particular an intake of an aircraft engine, an air intake device, a splitter fairing, a bulkhead, a nose cone, a landing gear fairing or a fuselage part. Those parts comprise double-curvature sections.

The issues are also addressed by the method as described herein. Thereby, a plurality of sets of fibers is produced to form a textile fabric structure which is at least partially woven and/or knitted from the set of fibers and wherein in at least one region of the structural element the number of fibers is reduced in one direction per area in a flattened out state of the textile fabric structure.

This can e.g. be achieved in one embodiment, where at least one first set of fibers is positioned automatically in a generally circumferential direction of the structural element and at least one second set of fibers is positioned automatically in generally parallel to the longitudinal axis of the aircraft part covering the frontal portion of the structural element and at least one third set of fibers is positioned automatically in generally parallel to the longitudinal axis but comprising at least one region with a reduced number of fibers in the frontal portion of the structural element.

This can e.g. be achieved by the automatic positioning of the set of fibers by computer controlled weaving and/or knitting. Using woven and/or knitted textile fibers allows the manufacturing of complex structural elements without having to assemble the structural elements from individual parts, such as prepreg slices, which leads to overlapping or wrinkling related issues.

In addition, a matrix material, in particular resin, is placed between the sets of fibers, in particular by the application of vacuum.

### BRIEF DESCRIPTION OF THE DRAWINGS

Embodiments of the invention are shown in the figures.

FIG. 1 shows a textile fabric structure for a structural element made with prepreg material according to the prior art; required overlapping areas of the prepreg slices are clearly visible.

FIG. 2 shows a flattened schematic view of a first embodiment of a textile fabric structure for an intake of an aircraft engine with three set of fibers.

FIG. 3 a flattened schematic view of a second embodiment of a textile fabric structure for an intake of an aircraft engine with two sets of fibers.

FIG. 4 shows a perspective view of the embodiment according to FIG. 2.

FIG. 5 shows a perspective view of the embodiment according to FIG. 3.

FIG. 6 shows a perspective view of an embodiment of an intake of an aircraft engine.

FIG. 6A shows a detail from the intake shown in FIG. 6.

FIG. 7 shows an embodiment of a structural element (air intake).

FIG. 8 shows a further embodiment of a structural element (splitter fairing).

### DETAILED DESCRIPTION

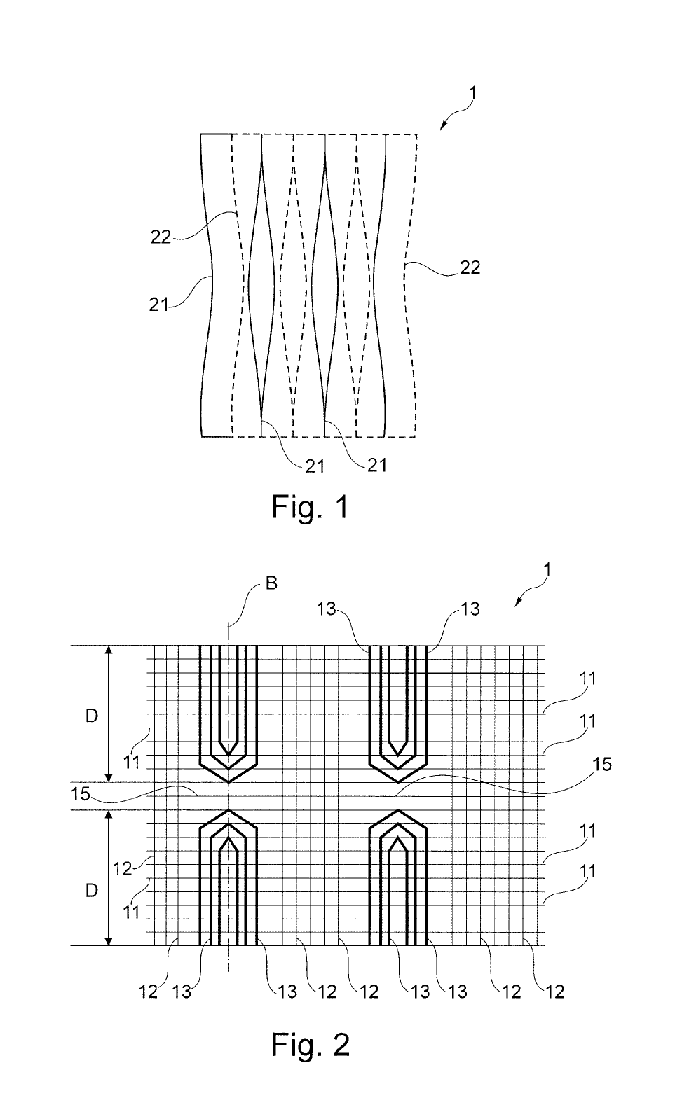

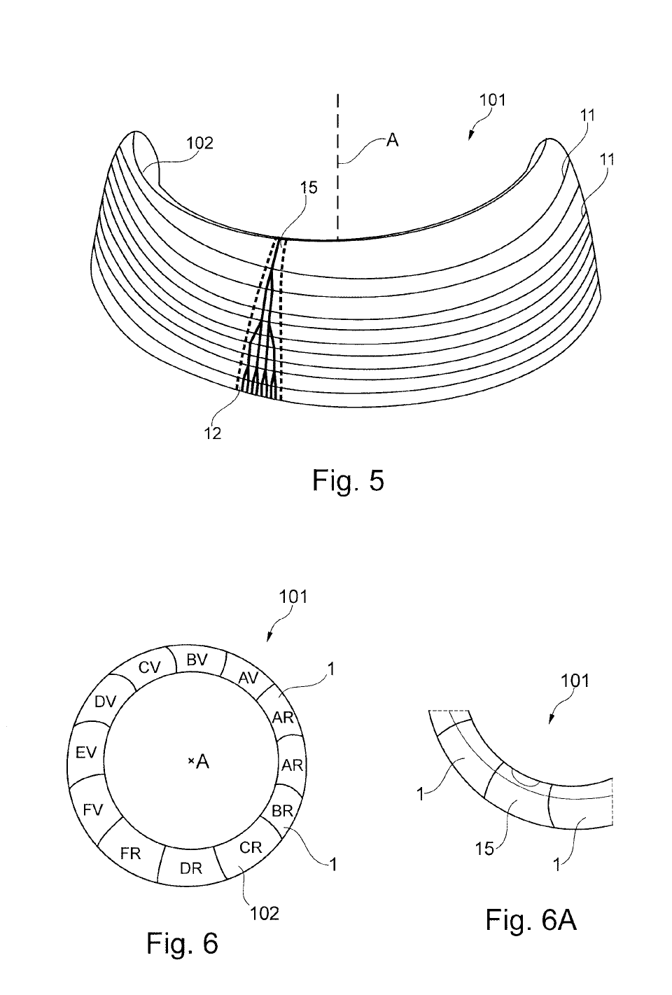

FIG. 1 shows a flattened out textile fabric structure 1 known in the prior art which can e.g. be used to form a structural element 101 with a double-curvature to be used in an aircraft engine (see e.g. FIGS. 6, 6A).

The textile fabric structure 1 comprises sets of fibers in two prepreg layers 21, 22 in which the fibers are oriented in different ways. A prepreg layer 21, 22 comprises fibers in a layer and resin.

The first prepreg layer 21 (solid lines) comprises fibers under, for example, a 90° orientation. The second prepreg layer 22 (dotted lines) comprises fibers under a 90° orientation. The individual prepreg layers 21, 22 roughly have an hour-glass shape so that the prepreg layers 21, 22 can be positioned on a double-curvature shape surface like the intake 101 of the aircraft engine. The double-curvature shape implies here a ring-like structure of the intake 101 in one direction and a curvature in the axial direction of the intake 101 of the aircraft engine.

It should be noted that same principle would be used for next set of layers, for example 45° or 90° or any other arbitrary angle.

Given the shape of the individual prepreg layers 21, 22, at least two overlapping layers of slices 21, 22 are needed to completely cover a surface. The overlap results in an uneven surface. The overlap is used to cover up for the discontinuation of the sliced ply.

The same effect would occur if e.g. rectangular shaped strips of thin material would be taped on a sphere along longitudinal directions on the sphere. In the regions of the sphere's poles the strips would overlap.

In FIG. 2, a first embodiment of a flattened out textile fabric structure 1 is shown which can also be shaped into a three-dimensional structural element 101, such as an intake 101 of an aircraft engine. The textile fabric structure 1 comprises three different sets of fibers 11, 12, 13.

The three sets of fibers 11, 12, 13 are joined together, e.g. by weaving and/or knitting. Therefore, the textile fabric structure 1 does not require overlapping prepreg segments.

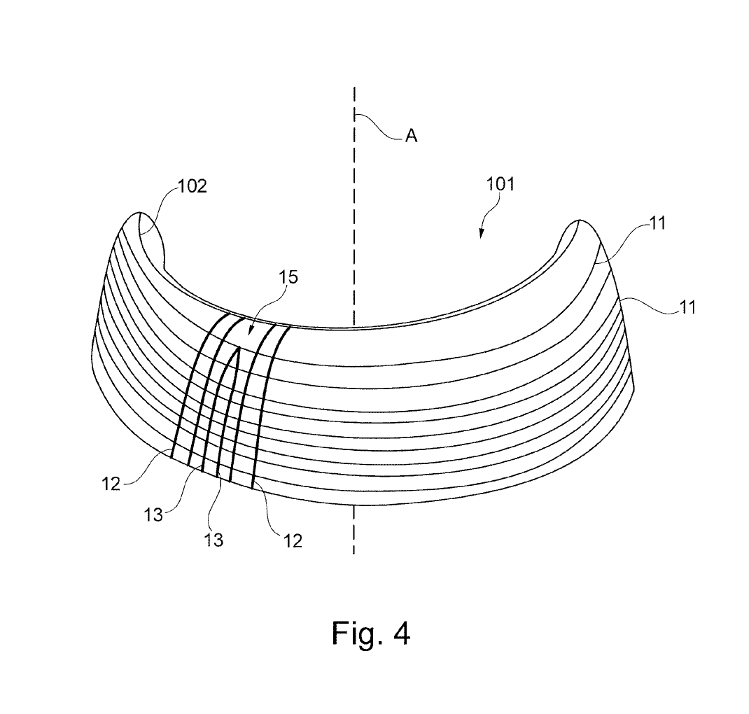

The first set of fibers 11 comprises circumferential fibers, i.e. fibers which in the completed intake 101 will run on the circumference of the intake 101 (see e.g. FIGS. 4, 5, 6, 6A).

The second set of fibers 12 are longitudinal fibers, i.e., here, fibers which extend in the axial direction of the axis A (see FIG. 4) around the intake 101 when completed.

The third set of fibers 13 are longitudinal fibers but in this case those fibers do not extend across the complete textile fabric structure 1 like the second set of fibers 12. The fibers of the third set of fibers 13 only extend from the rim of the textile fabric structure 1 into the interior for a certain distance D. Since the third set of fibers 13 extends from both rims into the interior along a common orientation axis B, a gap 15, i.e. a region 15, with a reduced number of fibers is formed between those third sets of fibers 13. The orientation axis B is a symmetry axis in the axial direction for the third set of fibers 13.

The region 15 with the reduced number of fibers (i.e. the gap 15) comprises only the first and second set of fibers 11, 12. In (schematic) FIG. 2 the textile fabric structure 1 is shown flattened out to show the deliberate thinning of fibers in certain regions. When assembled (see FIG. 4), the fiber density in the double-curvature region will become higher, almost similar to general fiber density.

Compared to the structure according to the prior art (FIG. 1), the embodiment of the textile fabric structure 1 in FIG. 2 shows some kind of hour-glass structure as well. But this is not created by individual prepreg layers 21, 22 but deliberately creating regions 15 with a reduced number of fibers. The third set of fibers 13 is creating a similar overall structure but with very different means.

In the embodiment shown, the gap 15 would be at the frontal portion 102 of the intake 101 of the aircraft engine (see FIGS. 4, 5, 6, 6A), i.e., at the region of a double-curvature. A first curvature is at the circumference of the intake part of the aircraft engine, the second curvature is oriented in axial direction.

The textile fabric structure 1 in FIG. 2 would be wrapped around or forms the frontal portion 102 along the axial direction A of the aircraft engine (upper and lower rim of the textile fabric structure 1 folded to the back) and in the circumferential direction (left and right rim of the textile fabric structure 1 folded together).

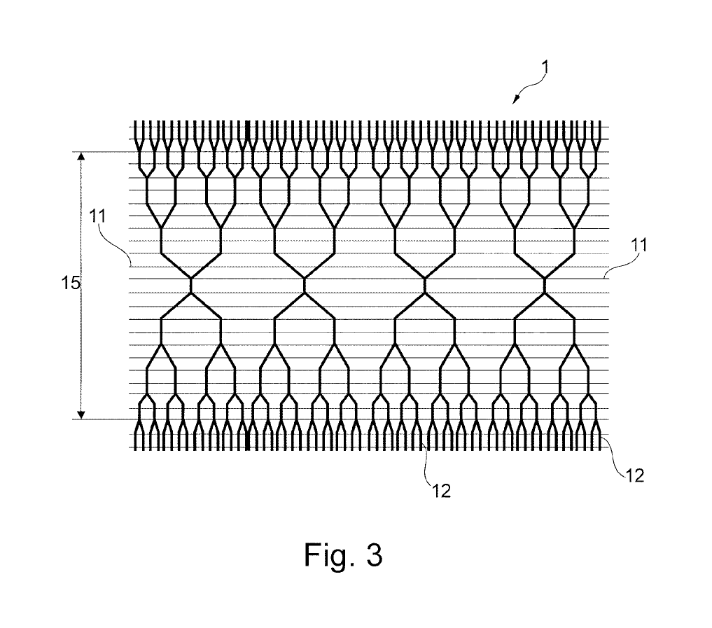

The thinning of the fibers, as shown in (the schematic views of) FIGS. 2 and 3 is apparent only in a developed (i.e. flattened, in-plane) shape of the textile fabric structure 1.

When the textile fabric structure 1 is built in, e.g. becoming a part of a structural element 101, the “gaps” 15 will contract around the high curvature areas (like the frontal portion 102 in FIGS. 4 and 5) and enable constant fibers density over double-curvature shaped surface.

In FIG. 3 an alternative embodiment of a textile structure 1 is shown in which a region with a reduced number of fibers is used.

Here, two sets of fibers 11, 12 are used. The first set 11 is a horizontal basis. Across this first set 11 a second set of fibers 12 is applied essentially orthogonally, e.g. by weaving or knitting.

The second set of fibers 12 thins out towards the middle of the textile structure 1 thereby creating a region 15 with a reduced number of fibers. The reduction is achieved by gradually thinning out the second set of fibers 12 as the fibers extend towards the middle of the textile structure 1.

The embodiments shown in FIGS. 2 and 3 show the systematic thinning out effect to create a region 15 with a reduced number of fibers. The effect is that in parts where the set of fibers 11, 12, 13 come closer together—and thereby increasing the density of fibers per unit area—the deliberately thinning out of the textile structure 1 in this region 15 counterbalances this effect and therefore keeps the density of fibers per unit area more or less constant.

Again, the reduced number of fibers is apparent only in the developed (i.e. flattened, in-plane) shape.

An application is described schematically in connection with FIG. 4 in which a section of textile fabric structure 1 for the intake 101 is shown. FIG. 4 uses the textile fabric structure 1 as shown in FIG. 2. Only a few of the sets of fibers 11, 12, 13—in the layout generally described in FIG. 2—are indicated here for the sake of simplicity. The gap 15, i.e., the region with the reduced number of fibers, is located at the frontal portion 102, i.e. the highlight and area of the maximum curvature in the axial direction. This shows that a splice free textile fabric structure 1 can be manufactured in one piece.

FIG. 5 is analogue to FIG. 4 in the sense that it shows a structural element 101 formed from the textile fabric structure 1 as shown in FIG. 3.

The proposed weaving and/or knitting fiber preparation/layup method is particularly good in the areas where big changes of the engine's parts' circumference, like the nacelle parts (in particular for engine inlet, cowls, thrust reverser and nozzle) occur. A combination of gather-knitting (for drawing fibers closer together laterally) and weaving methods is used in the areas where the fabrics naturally need to be compacted in the areas of the reduced circumference. In the example case (shown in FIG. 4), warp fibers, i.e., the first set of fibers 11, are laid in circumferential direction, while weft fibers, the second set of fibers 12, are laid in quasi-axial direction. The axial propagation of the weft fibers is controlled and, where necessary (like the region 15), the weft fibers 12 are stopped from propagating (like shown with the region 15). This way, a continuous weave can be achieved over very complex surfaces without any overlapping or squashing of the fabric, leading to a structurally and esthetically optimized final product.

In particular, it is possible to generate essentially hose-like structural elements in the same way as socks are knitted.

The three-dimensional textile fabric structure 1 shown in FIG. 4 forms part of an intake 101 as shown in FIGS. 6 and 6A. The complete intake 101 section shown in FIG. 5 is assembled from twelve textile fabric structures 1. In the enlarged view of FIG. 6A the gap 15, i.e. the region with the reduced number of fibers is shown at the frontal portion 102 of the intake 101.

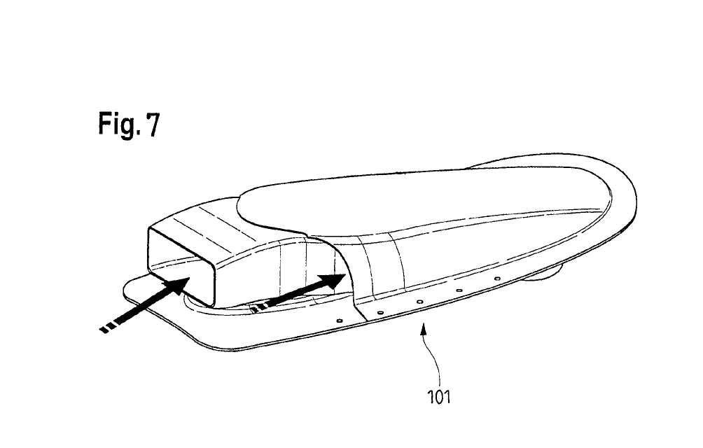

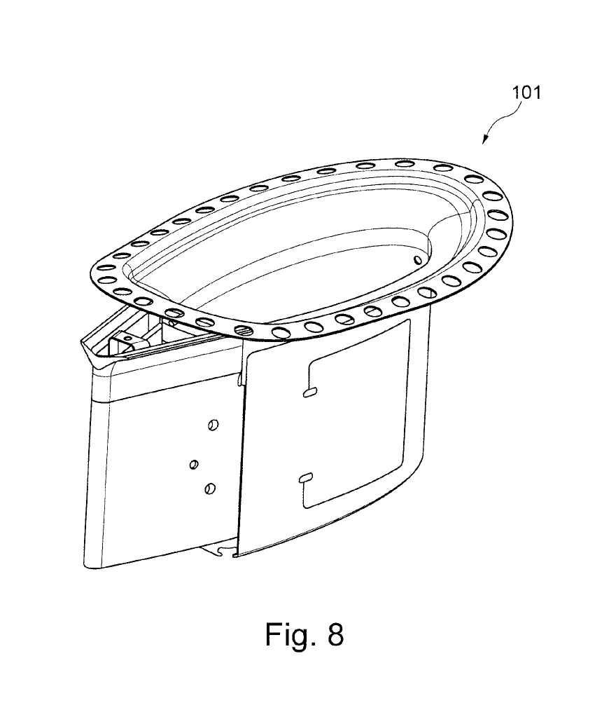

In FIGS. 7 and 8 further structural elements 101 are shown to indicate the versatility of the applications in context of an turbo aircraft engine.

In FIG. 7 an air intake is shown which can e.g. be used to channel air from the outside of the fuselage into the interior or to channel air from a bypass duct into the core engine.

In FIG. 8 a splitter fairing is shown which is e.g. used to guide the air flow in a bypass duct of an aircraft engine. The splitter fairing can e.g. be used to cover structural parts extending through the bypass duct.

### LIST OF REFERENCE NUMBERS

1 Textile fabric structure
11 First set of fibers
12 Second set of fibers
13 Third set of fibers
15 Region with a reduced number of fibers
101 Structural element, e.g., part of an intake of aircraft engine
102 Frontal portion of the intake
A Longitudinal axis of the aircraft engine
B Orientation axis of a set of fibers
D Distance of fibers extending from a rim of a fabric into the interior

1-15. (canceled)

16. A structural element of an aircraft part with at least partly a double-curvature shape, comprising a plurality of sets of fibers in textile fabric structure, wherein in at least one region of the structural element the number of fibers in one direction is reduced per area in a flattened out state of the textile fabric structure.

17. The structural element according to claim 16, wherein the reduction of fibers in the at least one region of the textile fabric structure creates a gap due to a reduced density of fibers, which is changed once fibers enveloped over the double-curvature shape.

18. The structural element according to claim 16, wherein the region with the reduced number of fibers in the textile fabric structure is located in an area with a maximum curvature in the structural element in at least one spatial direction.

19. The structural element according to claim 16, wherein the fiber density in the region of the double-curvature shape is uniform or essentially uniform.

20. The structural element according to claim 16, wherein the region with the reduced number of fibers is positioned in a circumferential direction of the structural element.

21. The structural element according to claim 16, wherein the set of fibers is splice-free oriented and/or positioned to form the structural element.

22. The structural element according to claim 21, wherein the set of fibers has a three-dimensional structure.

23. The structural element according to claim 16, wherein the structural element comprises a set of fibers at least partially overlapping between each other in the region with reduced number of fibers.

24. The structural element according to claim 16, wherein the set of fibers is at least partially in different textile layers.

25. The structural element according to claim 16, wherein the structural element comprises a double-curvature shape form with a first curvature around a closed circumference and a second curvature in axial direction.

26. The structural element according to claim 16, wherein the at least three sets of fibers are embedded in a matrix material, forming a composite structural element.

27. The structural element according to claim 26, wherein the at least three sets of fibers are layers of carbon fibers, Kevlar fibers and/or glass fibers.

28. The structural element according to claim 26, wherein the matrix material is a resin.

29. The structural element according to claim 16, wherein the structural element is part of the aircraft part.

30. The structural element according to claim 29, wherein the structural element is a three-dimensional axisymmetric part.

31. The structural element according to claim 30, wherein the three-dimensional axisymmetric part is an intake of an aircraft engine, an air intake device, a splitter fairing, a bulkhead, a nose cone, a landing gear fairing or a fuselage part.

32. A method for manufacturing a structural element of an aircraft part, wherein a set of fibers forms a textile fabric structure which is at least partially woven and/or knitted from the set of fibers, wherein in at least one region of the structural element the number of fibers in one direction is reduced per area in a flattened out state of the textile fabric structure.

33. The method according to claim 32, wherein
at least one first set of fibers is positioned automatically in a generally circumferential direction of the structural element and
at least one second set of fibers is positioned automatically in generally parallel to the longitudinal axis of the aircraft part covering the frontal portion of the structural element and
at least one third set of fibers is positioned automatically in generally parallel to the longitudinal axis but comprising at least one region with a reduced number of fibers in the frontal portion of the structural element.

34. The method according to claim 32, wherein the automatic positioning of the set of fibers comprises computer controlled weaving and/or knitting.

35. The method according to claim 32, wherein a matrix material, in particular resin, is placed between the sets of fibers, in particular by the application of vacuum.
